(19) United States
(12) Patent Application Publication
(10) Pub. No.: US 2015/0058810 A1
(43) Pub. Date: Feb. 26, 2015

(54) Electronic Device with Lateral Touch Control Combining Shortcut Function

(71) Applicant: Wistron Corporation, New Taipei City (TW)

(72) Inventor: Hung-Cheng Chang, New Taipei City (TW)

(73) Assignee: Wistron Corporation, New Taipei City (TW)

(21) Appl. No.: 14/133,661

(22) Filed: Dec. 19, 2013

(30) Foreign Application Priority Data
Aug. 23, 2013 (TW) 102130276

(51) Int. Cl. G06F 3/0488

(52) U.S. Cl. CPC G06F 3/0488
USPC 715/863

(57) ABSTRACT

An electronic device capable of simplifying user operation includes a shell having an opening; a displaying device disposed on the opening; and at least one lateral touch panel, disposed on one or more lateral parts of the shell, for generating a touch control signal according to a gesture applied on the at least one lateral touch panel; wherein the one or more lateral parts are connected to a plane where the opening is located and the external surface thereof is not parallel to the plane, and the electronic device executes a predefined function according to the touch control signal.

### BACKGROUND OF THE INVENTION

1. Field of the Invention

The present invention relates to an electronic device with touch control function, and more particularly, to a touch controlled electronic device capable of detecting a gesture applied on a lateral sidewall of the electronic device for executing a shortcut function.

2. Description of the Prior Art

Nowadays many electronic devices such as portable tablet device or smart phone have touch-controlled capabilities. Touch screens are often used as the primary input element for the electronic devices. Since the operation of the multi-touch functionality is in general limited to touch screens, the user needs to hold the electronic device by one hand but touch the screen by the other hand in order to accommodate the large dimension of the electronic device. When the user only needs to execute simple operations, he or she cannot complete the operations simply by one hand. Moreover, the merits of multi-touch functionality cannot be fully utilized when the user holds the electronic device by only one hand.

Therefore, it is a common goal in the industry to simplify the user operation of the electronic device so as to provide an easy-to-use interface for the user.

### SUMMARY OF THE INVENTION

The objective of the present invention is to provide an electronic device with a lateral touch control function. The electronic device is capable of detecting a gesture applied on its lateral sidewall for executing a shortcut function, so as to simplify the user operation and thus improve the efficiency and user convenience.

An embodiment of the invention discloses an electronic device capable of simplifying user operation including a shell having an opening; a displaying device disposed on the opening; and at least one lateral touch panel disposed on one or more lateral parts of the shell for generating a touch control signal according to a gesture applied on the at least one lateral touch panel; wherein the one or more lateral parts are connected to a plane where the opening is located and the external surface thereof is not parallel to the plane, and the electronic device executes a predefined function according to the touch control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1A to 1C are operational diagrams of an electronic system according to an embodiment of the invention.

FIG. 2 is a schematic diagram of an electronic device according to an embodiment of the invention.

FIG. 3 is a functional block of the electronic device shown in FIG. 2.

FIG. 4 is a flowchart of a process according to an example of the invention.

FIG. 5 is a flowchart of a process according to an example of the invention.

### DETAILED DESCRIPTION

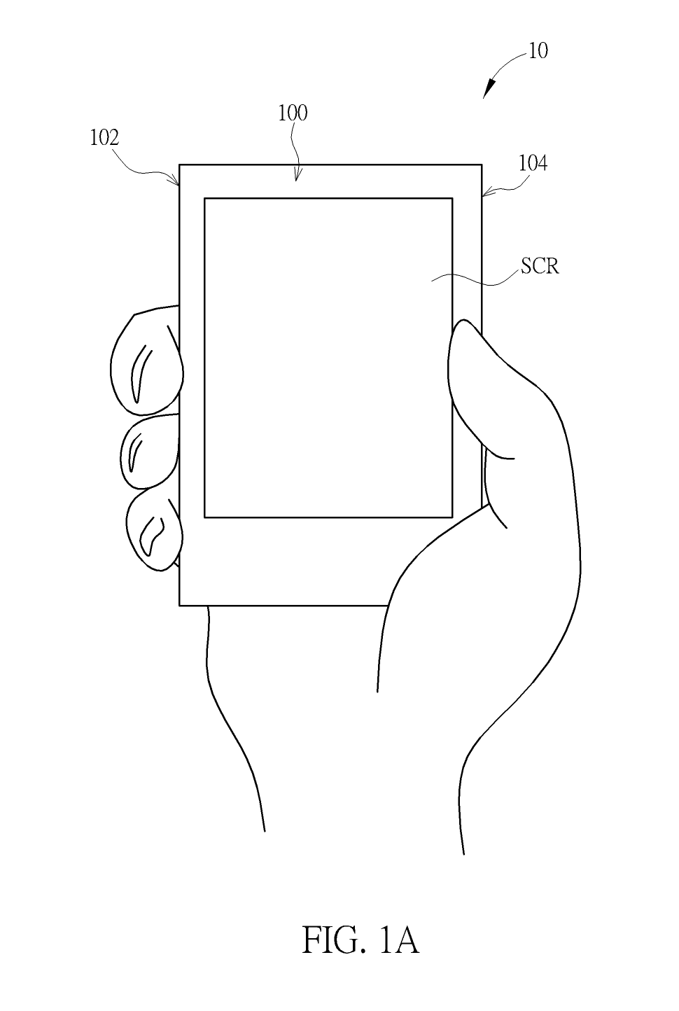

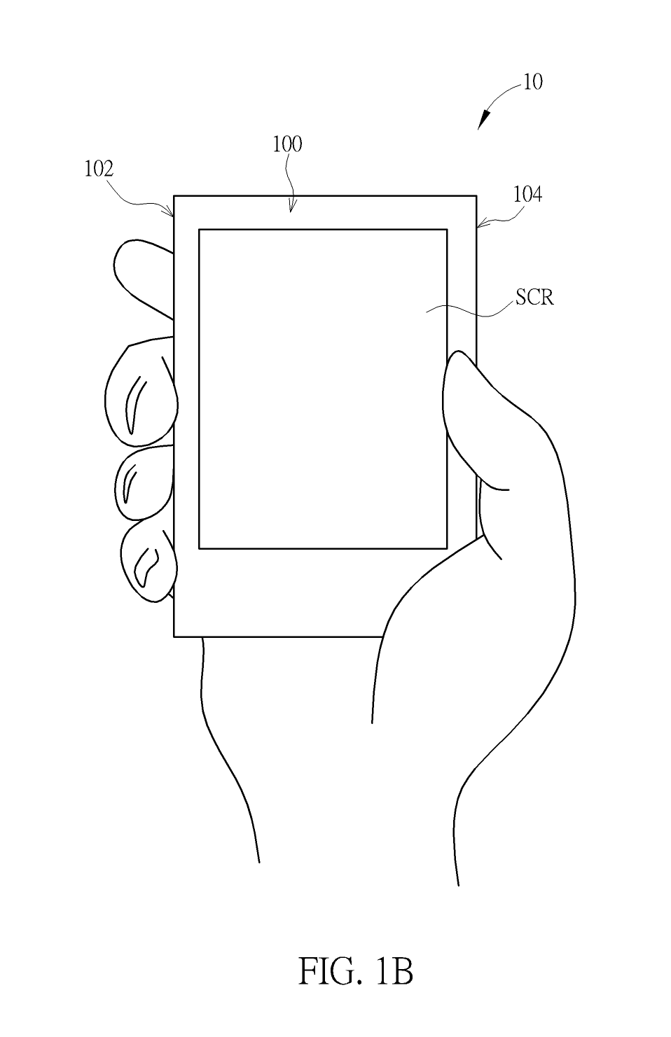

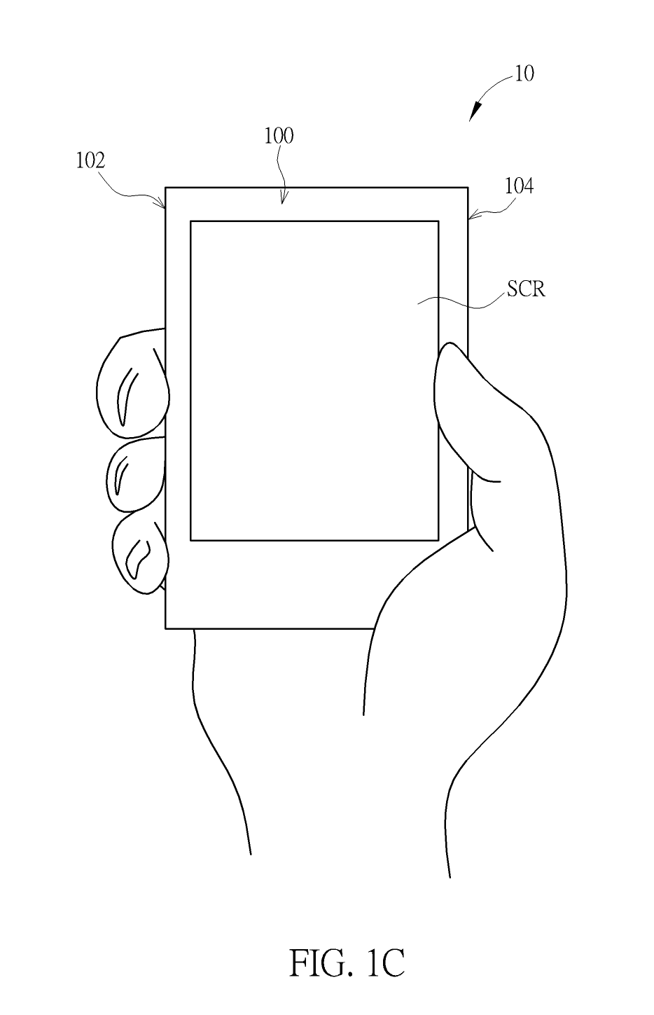

Please refer to FIGS. 1A to 1C, which are operational diagrams of an electronic system 10 according to an embodiment of the invention. The electronic system 10 may be any portable electronic device, such as a portable tablet PC, a smart phone, a laptop, a remote device, a Walkman, or a personal digital assistance (PDA), but is not limited herein. A displaying device is configured to the front plane 100 of the electronic device 10 to form a displaying screen SCR. In addition, at least one lateral touch panel is disposed at one of the sidewall (e.g. left side 102 and/or right side 104) of the electronic device 10. The lateral touch panel may be an independent projected capacitive touch panel having multi-touch functionality for sensing the multiple contact points in proximity with each other. When the electronic device 10 senses a specific gesture applied on the sides 102 and 104 by the user, a predefined function is executed. For instance, the displaying screen SCR may display differently in response to different gestures according to the predefined function. By applying tiny change of gesture on the lateral sidewall of the electronic device 10, the user can easily hold the electronic device 10 by only one hand while giving commands to the electronic device 10 for simple or complex operations. As such, the user operation of the electronic device 10 is simplified, thereby improving the efficiency and convenience of use.

As shown in FIG. 1A, when the lateral touch panel 102 disposed on the left side 102 is enabled, the electronic device 10 senses three contact points from the user's fingers, and then enters a standby mode of a lateral multi-touch function. Next, as shown in FIGS. 1A to 1C, when the number of contact points by the user' s figures changes from three to four and then back to three points within a certain time slot (e.g. 1 sec), a system of the electronic device 10 may perform a predefined function according to the change of the multi-touch gesture. When the user is reading an electronic book, the predefined function may be, for example, an instruction to turn to the next or the previous page of the electronic book so that the user can conveniently browse the book when holding the electronic device 10 by only one hand. Alternatively, the predefined function may be an instruction to launch certain simple functions, such as enabling/disabling or operating an application program, waking up or turning off the electronic device 10, putting the electronic device 10 into hibernation mode, turning on/off a functional module or applications (e.g. in a screen, email or specific application program) of the electronic device 10, executing a specific function (e.g. photo shooting) of the electronic device 10, or executing a shortcut function or a combined functionalities.

Moreover, the electronic device 10 may determine multiple contact points or combined touch control gestures, and perform multiple predefined functions according to multi-touch gestures or combined touch control signals. In other words, different gestures (i.e. user instructions), such as the touching speed, timing, duration, area, location, number of contact points, moving direction, status change, or their combinations, are correspondent to different predefined function executions of the electronic device 10. In addition, the user may customize a gesture and associate the customized gesture with a predefined function by his or her preference. For example, the user may configure to define a customized gesture such as a sequential changes from two-finger touch to four-finger and then to three-finger touch, or a gesture of which the user contacts the electronic device 10 with specific beats (i.e. specific time duration). As a result, the electronic device 10 maybe designed with less buttons, and allow the user activating the predefined function by using preferred gestures.

Noticeably, an objective of the present invention is to detect a gesture and the changes thereof applied on a lateral sidewall of the electronic device, so as to execute a shortcut function of the electronic device. The user operation of the electronic device is therefore simplified, which improves the usage efficiency. Those skilled in the art can make alterations and/or modifications accordingly. For example, the lateral touch panel disposed at the lateral sidewall of the electronic device 10 is not limited to a capacitive touch panel. Other types of touch control sensing components such as a resistive type, an electric wave type, an optical type, an electromagnetic type, or an in-cell touch panel, or components having image sensing function may be utilized as well. The number of the lateral touch panel is not restricted. The lateral touch panel is not restricted to be disposed on the left or the right sidewall of the electronic device 10, for example, to configure to other sides such as top or bottom sidewall of the electronic device 10 according to usage or application requirements. In addition, the application of the electronic device 10 may be applied to a single-handheld, a two-handheld, or a wearable device.

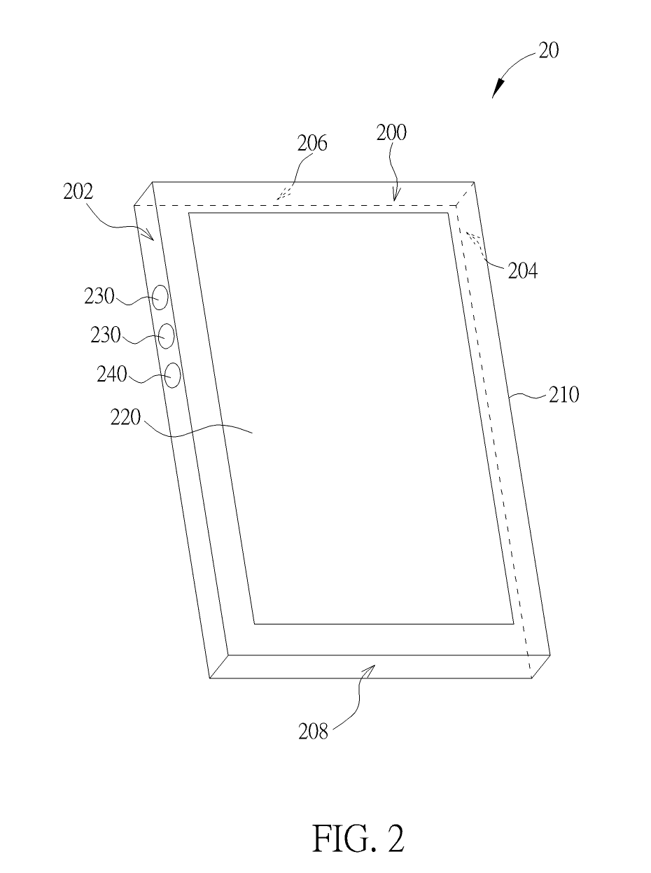

Please refer to FIG. 2, which is a schematic diagram of an electronic device 20 capable of simplifying user operation according to an embodiment of the invention. The electronic device 20 includes a shell, 210, a displaying device and at least one lateral touch panel. The shell 210 has an opening. The displaying device may be a touch screen 220 disposed on the opening to form a part of the front plane 200 of the electronic device 20. The one to a plurality of the lateral touch panels are disposed on at least one of the lateral sidewalls (e.g. the left side 202, the right side 204, the top side 206 or the bottom side 208) of the shell 210. In addition, the lateral touch control panels on the sidewalls 202, 204, 206 and 208 of the electronic device 20 are connected to the front plane 200, where the external surface thereof maybe substantially perpendicular to the front plane 200 or forming an acute or obtuse angle with the front plane 200. The external surface of the lateral sidewalls 202, 204, 206 and 208 may be a flat plane or a curved plane. The plane of the lateral touch panel 300 may be discontinuous or having a slot area for disposing one or more buttons 230 or one or more sensors 240.

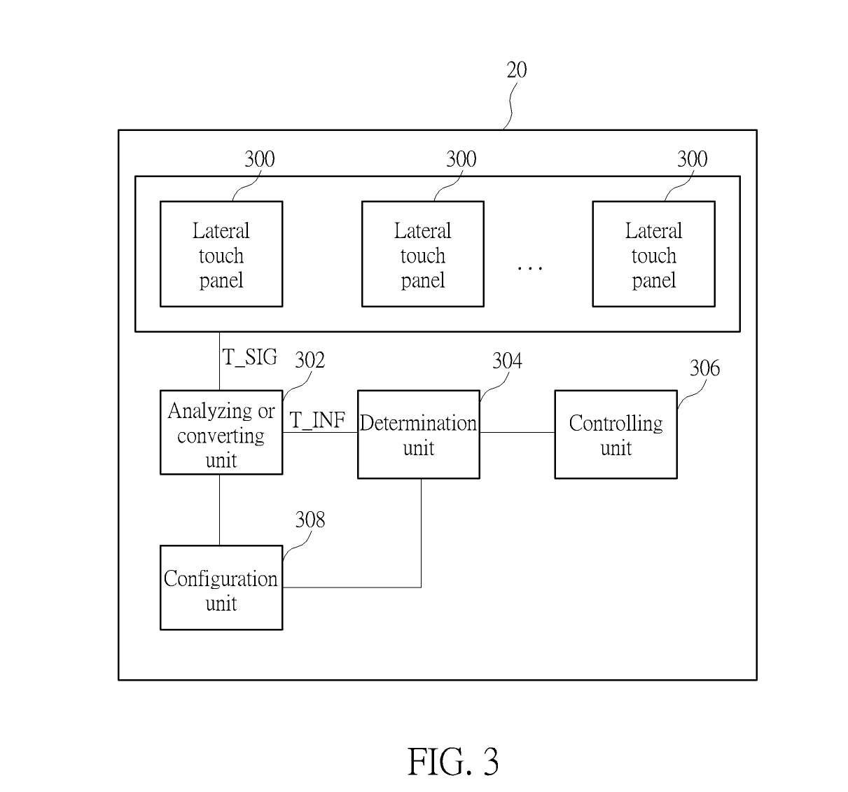

Please refer to FIG. 3, which is a functional block of the electronic device 20 shown in FIG. 2. When a gesture is applied on lateral touch panels 300 of the electronic device 20, the lateral touch panels 300 generate a touch control signal T_SIG corresponding to the gesture and then transmit the touch control signal T_SIG to an analyzing or converting unit 302. The analyzing or converting unit 302 receives the touch control signal T_SIG generated by the touch panel 300 and analyze or convert the touch control signal T_SIG to further generate the gesture information T_ING. After that, the analyzing or converting unit 302 transmits the gesture information T_ING to a determination unit 304 to determine whether the gesture corresponding to the touch control signal T_SIG matches a predefined gesture customized by the user or preconfigured in the system. When the gesture corresponding to the touch control signal T_SIG matches a predefined gesture, a controlling unit 306 of the electronic device 20, for example, the operating system or specific software, may execute the predefined function that binds to the predefined gesture accordingly.

In detail, the analyzing or converting unit 302 may be a standalone integrated circuit, a part of circuit being integrated into an application-specific integrated circuit (ASIC), or a sub-functional module of a microcontroller (MCU), but is not limited herein. The analyzing or converting unit 302 analyzes the touching speed, timing, duration, area, location, number of contact points, moving direction, status change, or their combinations and converts the analyzing result to the gesture information T_INF, and then transmits the information T_INF to the determination unit 304. For example, the analyzing or converting unit 302 may divide a sensing area of the lateral touch panel 300 into several specific regions, wherein different specific regions are corresponded to different gesture information T_INF. Moreover, the electronic device 20 may further include a configuration unit 308 to decide whether to enable one or more lateral touch panels 300 in the sidewalls (e.g. only enable one of the lateral touch panels 300), or to allow user to manually define a handheld manner (e.g. for left-hand use or right-hand use). Alternatively, the electronic device 20 may intelligently or automatically detect by which hand the user is holding the electronic device 20, so as to convert the detection result to appropriate setting automatically. For example, as shown in FIG. 1A to FIG. 1C, the user contacts the left side 102 of the lateral touch panel 300 by his right hand. In a time prompt when the user changes to contact the right side 104 of the lateral touch panel 300 by his left hand, the analyzing or converting unit 302 may analyze the contact number of user finger, how long the user contacts the lateral touch panel 300, the contact area, the source of the touch control signal, or combining a sensing result of, for example, a gravity sensor in order to automatically determine handheld manner as to correspond the gestures with the predefined functions.

Furthermore, the predefined function activated from the abovementioned instruction is not limited to the gesture applied on the lateral touch panel 300. The touch control signal of the lateral touch panel 300 maybe combined with the touch control signal applied on the touch screen 220 to form a composite touch-controlled instruction and execute a predefined function. Alternatively, the electronic device 20 may include buttons 230 disposed on the front plane, sidewall or back plane for the user to control the power supply or adjust the audio volume, etc. of the electronic device 20 with convenience. In the present invention, the control signal of the buttons 230 may be combined with the touch control signal of the lateral touch panel 300 in order to form another composite touch-controlled instruction. Moreover, the electronic device 20 may further include a sensor 240, such as a light sensor, for sensing movement of the user, and converting the movement to a control signal so as to execute the predefined function. Furthermore, a composite gesture may be bind to a combination of the control signal of the sensor 240, the touch control signal of the lateral touch panels 300 and the touch screen 220, and the control signal of the buttons 230, to represent a touch-controlled instruction. In short, the lateral touch panel 300, the touch screen 220, the buttons 230, and the sensor 240 may cooperate to receive various kinds of gestures of the user, so as to execute different kind of functions.

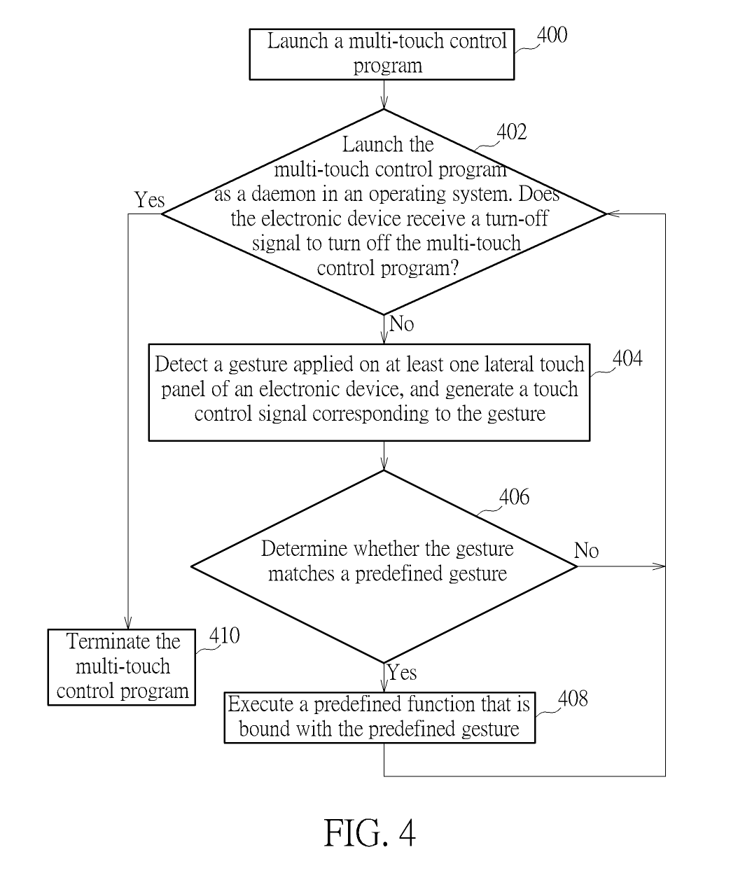

The operation of combining shortcut function for an electronic device with lateral touch control can be summarized into a process 40 as shown in FIG. 4. The process 40 includes the following steps:

Step 400: Launch a multi-touch control program.

Step 402: Launch the multi-touch control program as a daemon in an operating system. If the electronic device receives a turn-off signal to turn off the multi-touch control program, go to Step 410; otherwise, execute Step 404.

Step 404: Detect a gesture applied on at least one lateral touch panel of an electronic device, and generate a touch control signal corresponding to the gesture.

Step 406: Determine whether the gesture matches a predefined gesture. If yes, go to Step 408; otherwise, go to Step 402.

Step 408: Execute a predefined function that is bound with the predefined gesture. Then, go back to Step 402.

Step 410: Terminate the multi-touch control program.

The process 40 may be utilized in the determination unit 304 of the electronic device 20. The determination unit 304 maybe a daemon service embedded in the operating system of the electronic device 20 after the electronic device 20 is booted. Alternatively, the determination unit 304 maybe an application program that is manually launched by the user. The determination unit 304 is used for receiving multi-touch control signals, determining the gesture, and instructs the controlling unit 306 to execute the predefined function accordingly.

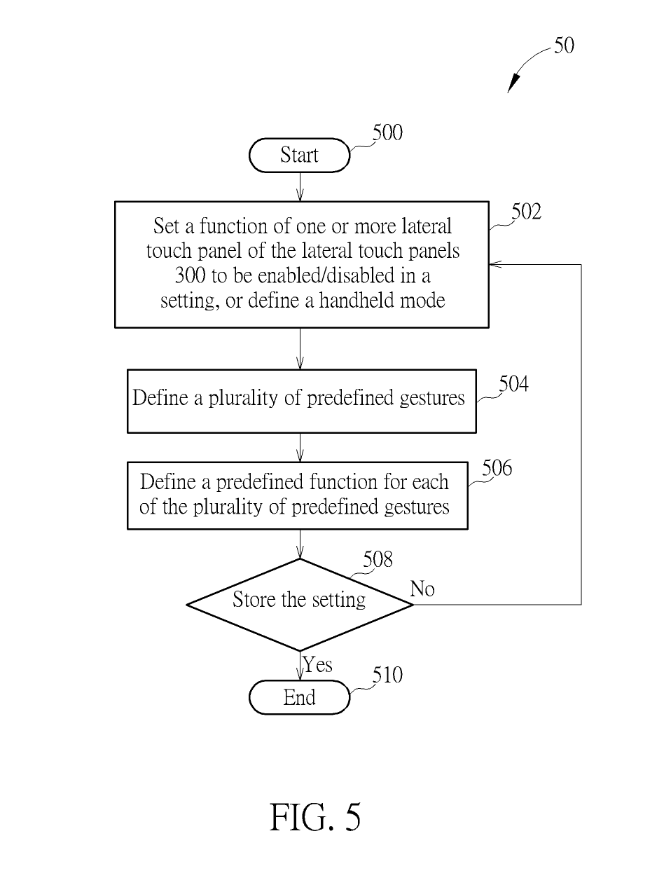

In addition, please refer to FIG. 5 for a configuration initializing process of the abovementioned application program. The process 50 may be used in the electronic device 20 shown in FIG. 3, and may be realized by the determination unit 304 and the configuration unit 308. The process 50 includes the following steps:

Step 500: Start.

Step 502: Set a function of one or more lateral touch panel of the lateral touch panels 300 to be enabled/disabled in a setting, or define a handheld mode.

Step 504: Define a plurality of predefined gestures.

Step 506: Define a predefined function for each of the plurality of predefined gestures.

Step 508: Store the setting.

Step 510: End.

The method to implement the abovementioned examples and the processes 40 and 50 is not restricted to the ways of software, hardware, or firmware. Instructions to execute predefined functions may be stored as an execution code in a memory of the electronic devices 10 and 20 in advance. Alternatively, the instructions may be burned in the firmware, or hard-coded in the operating system, daemon, or configuration files of application programs. In other examples, the instructions may be added, removed, or modified by updating the firmware, the configuration of the operating system, or the configuration of application programs. The operating system such as the Microsoft Windows Mobile, Microsoft Windows CE, Symbian, Palm, iOS, Android, or Linux system installed in the electronic devices 10 and 20 may be the control unit 306, which instructs a specific program to execute the predefined function according to the signal received from the determination unit 304.

To sum up, the present invention provides multi-touch functionality by incorporating the touch control signals of lateral panels of the electronic device to define the gestures and bind the gestures with predefined instructions. With the aid of the application program, various kinds of gestures can be bound to predefine functions and be configured based on the user's definition including handheld mode. As a result, the user can easily and rapidly operate the electronic device 20 by applying different gesture on the lateral of the electronic device when holding the electronic device by only one hand. Therefore, the user operation of the electronic device is simplified, and the efficiency and convenience of use is improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device capable of simplifying user operation, comprising:
a shell, having an opening;
a displaying device, disposed on the opening; and
at least one lateral touch panel, disposed on one or more lateral parts of the shell, for generating a first touch control signal according to a first gesture applied on the at least one lateral touch panel;
wherein the one or more lateral parts are connected to a plane where the opening is located and the external surface thereof is not parallel to the plane, and the electronic device executes a predefined function according to the first touch control signal.

2. The electronic device of claim 1, further comprising:
a determination unit, for determining whether the first gesture matches a predefined gesture in order to generate a determination result, and the electronic device executes the predefined function according to the determination result.

3. The electronic device of claim 2, wherein the determination unit is an application program, and the application program is a daemon in a system of the electronic device or a regular application program executed by a user.

4. The electronic device of claim 2, further comprising:
an analyzing or converting unit, coupled to the at least one lateral touch panel, for receiving and analyzing or converting the first touch control signal to generate a gesture information, and transmitting the gesture information for the determination unit to determine whether the first gesture matches the predefined gesture.

5. The electronic device of claim 4, wherein the analyzing or converting unit consists of a standalone integrated circuit, or is integrated into an application-specific integrated circuit or a microcontroller.

6. The electronic device of claim 1, further comprising:
a configuration unit, for whether to activate one or more sidewall panels of the at least one lateral touch panel or defining a handheld manner so as to determine a setting information, and the electronic device executes the predefined function according to a combination of the first touch control signal and the setting information.

7. The electronic device of claim 6, wherein the electronic device intelligently or automatically determines the setting information according to the first gesture.

8. The electronic device of claim 1, wherein the displaying device is a touch screen, for generating a second touch control signal according to a second gesture applied on the touch screen, and the electronic device executes the predefined function according to a combination of the first touch control signal and the second touch control signal.

9. The electronic device of claim 1, further comprising:
one or more functional buttons or sensors, for a user to control the electronic device or for sensing an action of the user, to generate a control signal;
wherein the electronic device executes the predefined function according to a combination of the control signal and the first touch control signal.

10. The electronic device of claim 1, wherein the electronic device executes the predefined function further according to touching speed, timing, duration, area, location, number of contact points, moving direction or status change of the first gesture.

11. The electronic device of claim 1, wherein the predefined function is to enable/disable or operate an application program, to wake up or turn off the electronic device, to put the electronic device into hibernation mode, to turn on/off a functional module of the electronic device, to execute a specific function of an application program, or to execute a shortcut function or a combined function.

12. The electronic device of claim 1, wherein the at least one lateral touch panel is disposed on the left, right, top, or bottom side of the electronic device.

13. The electronic device of claim 1, wherein the at least one lateral touch panel is a capacitive touch panel.
